(19) United States
(12) Patent Application Publication
(10) Pub. No.: US 2008/0115836 A1
(43) Pub. Date: May 22, 2008

(54) Structure of temperature-controlled infrared sensor water faucet

(75) Inventor: Yu-You Hsieh, Hemei Township (TW)

Correspondence Address: TROXELL LAW OFFICE PLLC, 5205 LEESBURG PIKE, SUITE 1404, FALLS CHURCH, VA, 22041, US

(73) Assignee: Deluxe Brassware Co., Ltd.

(21) Appl. No.: 11/600,901

(22) Filed: Nov. 17, 2006

(51) Int. Cl. G05D 11/02

(52) U.S. Cl. 137/88

(57) ABSTRACT

An improved structure of temperature-controlled infrared sensor water faucet, which is comprised by cool water supply pipe and hot water supply pipe assembled from bottom to upward so that the mixing control ceramic valve installed in the upper valve slot can control cool and hot water as required, and the vertical water faucet can supply cool/hot water or mixed water with set temperature; wherein warm water supply pipe with downward water channel at one top to bear the adjusted warm water and side exit water outlet at one top are respectively put through the front of valve slot under the mixing control ceramic valve and cool & hot water supply hole, the adjusted warm water can flow out the outlet handle from the warm water drainage channel. Basing on this structure, the warm water supply channel and drainage channel can respectively be connected to the water supply inlet and outlet of an infrared sensor via water supply pipe and drainage pipe; which is connected out with an infrared sensor, and as the sensing terminal installed in the middle of the front side of water faucet inducts the hands moving toward lower part of outlet handle, it starts the infrared sensor and opens the internal water supply valve, warm water after adjusted is conducted into water supply inlet through the downward water channel, warm water supply channel and water supply pipe, then drain it upward to the drainage pipe and flow out from the outlet handle of water faucet, so that the upper mixing control ceramic valve can directly set and adjust warm water, such infrared sensor water faucet features in simple structure and easy operation.

### BACKGROUND OF THE INVENTION

1) Field of the Invention

This invention relates to an improved structure of temperature-controlled sensor water faucet, which is to provide a simple structure to integrate the vertical and single water faucet with an infrared sensor; and warm water supply and drainage pipe is respectively put through the front of cool and hot water hole of the valve slot under mixing control valve of water faucet so as to connect the warm water supply pipe and drainage pipe with the water supply inlet and outlet of an infrared sensor; which is connected out with an infrared sensor, and as the sensing terminal installed in the middle of the front side of water faucet issues instructions to supply water at fixed time and quantity, warm water is conducted into water supply inlet, namely, drain it from outlet to drainage pipe, then move upward to the outlet handle of water faucet and go out, so that user can set or adjust temperature of water easily.

2) Description of the Prior Art

Usually, the sensor water faucet equipped with infrared device that can turn on/off water automatically as required has been broadly applying under consideration of sanitation, simple structure and the capability to supply water in fixed quantity. However, the traditional sensor water faucet is mainly used for supplying cool water, which is usually equipped at hand wash basin in public; however, its usage may be limited in cold weather, therefore, such sensor water faucet has not been applied to home decoration.

In order to improve the shortcoming of above said sensor water faucet, people invented a sensor water faucet that can supply the mixed cool and hot water. However, such water faucet can only supply cool and hot water in fixed scale, besides, its structure is complex and production cost is high, furthermore, said sensor water faucet is operated as same as the traditional constant temperature water faucet, so, it is inconvenient to operate and user may make wrong operation, as it induces water automatically, the hot water might scald user or cold water scare user, therefore, its applicability is further limited.

In order to improve the shortcoming of above said sensor water faucet, the inventor hereby provides a temperature-controlled sensor water faucet structure that can supply cool and hot water respectively or at the same time, especially, it is equipped with the mixing control ceramic valve and infrared sensor.

### SUMMARY OF THE INVENTION

The key purpose of this invention is to provide an improved structure of temperature-controlled sensor water faucet; wherein warm water supply and drainage pipe is respectively put through the front of the valve slot of mixing control valve of water faucet so as to connect the warm water supply pipe and drainage pipe with the water supply inlet and outlet of an infrared sensor; which is connected out with an infrared sensor, and as the sensing terminal installed in the middle of the front side of water faucet issues directions to supply water at fixed time and quantity, the suitable warm water is conducted into water supply inlet, namely, drain it from outlet to drainage pipe, then move upward to the outlet handle of water faucet and go out, so that user can set or adjust temperature of water easily with the mixing control ceramic valve installed at top of the water faucet.

The second purpose of this invention is to provide said improved structure of temperature-controlled sensor water faucet; wherein the warm water supply pipe and drainage pipe can be connected with the water supply inlet and outlet of an infrared sensor basing on the cool and hot water hole of the water faucet and the warm water supply and drainage channel; so that the sensing terminal issues directions to supply water at fixed time and quantity, therefore, the structure of said invention is simple and also reduce the rate of trouble.

### BRIEF DESCRIPTION OF THE DRAWINGS

FIG. 1 is the exploded view of structure of this invention

FIG. 2 is the exploded combination view of structure of this invention

FIG. 2-A is the diagram of this invention for cool, hot and warm water supply

FIG. 2-B is the diagram of this invention for cool, hot and warm water supply

FIG. 3 is the combination structure and horizontal cutaway view of sensor water supply of this invention

FIG. 4 is the diagram of cool and hot water supply

FIG. 5 is the outlet diagram of warm water supply

### DETAILED DESCRIPTION OF THE PREFERRED EMBODIMENTS

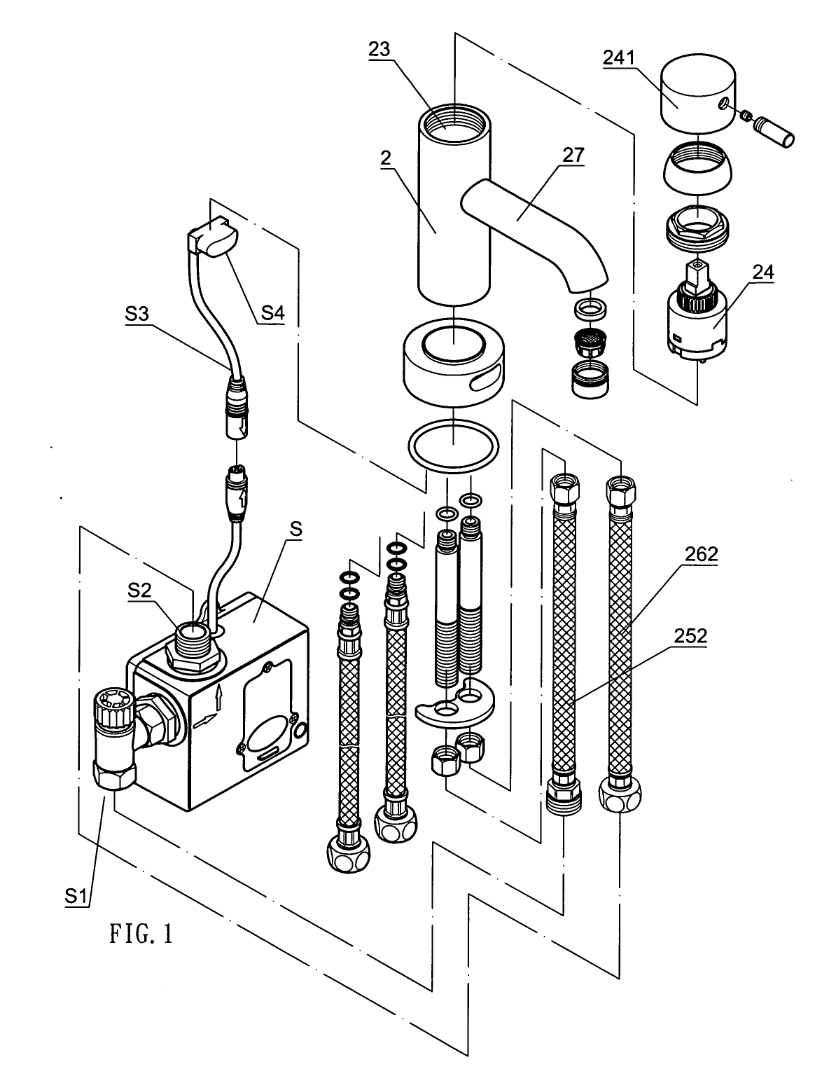

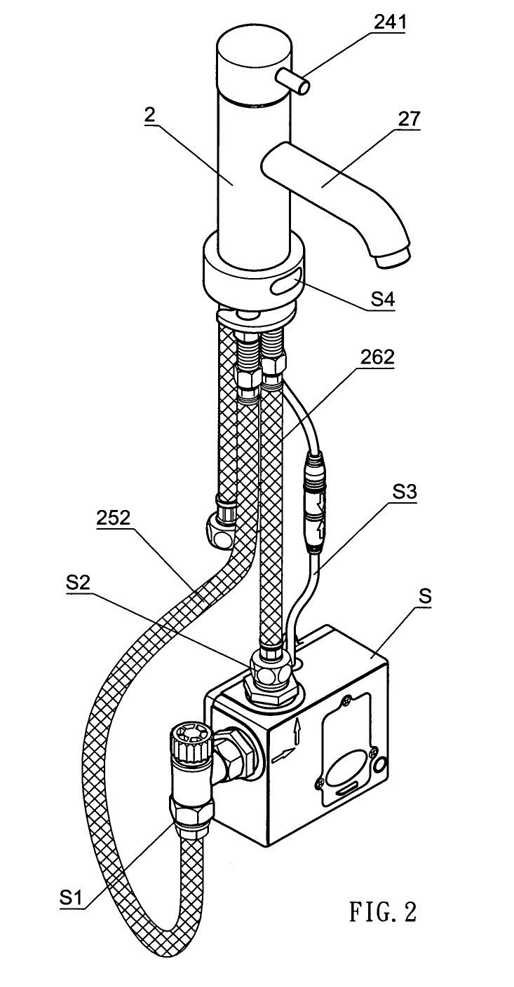

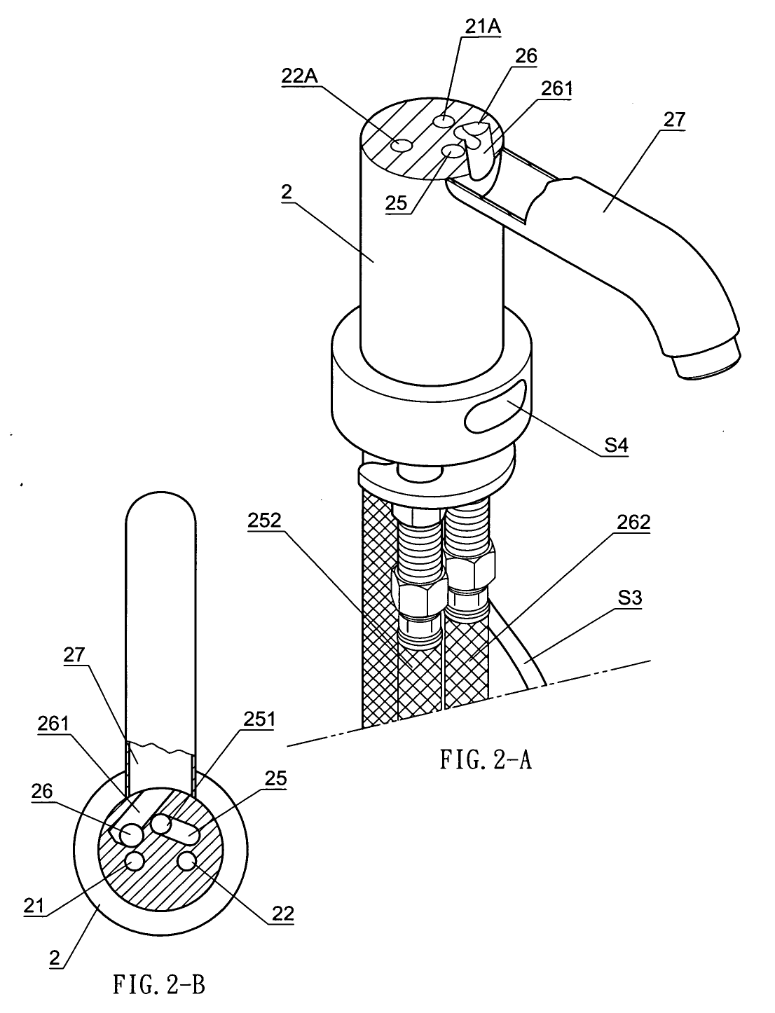

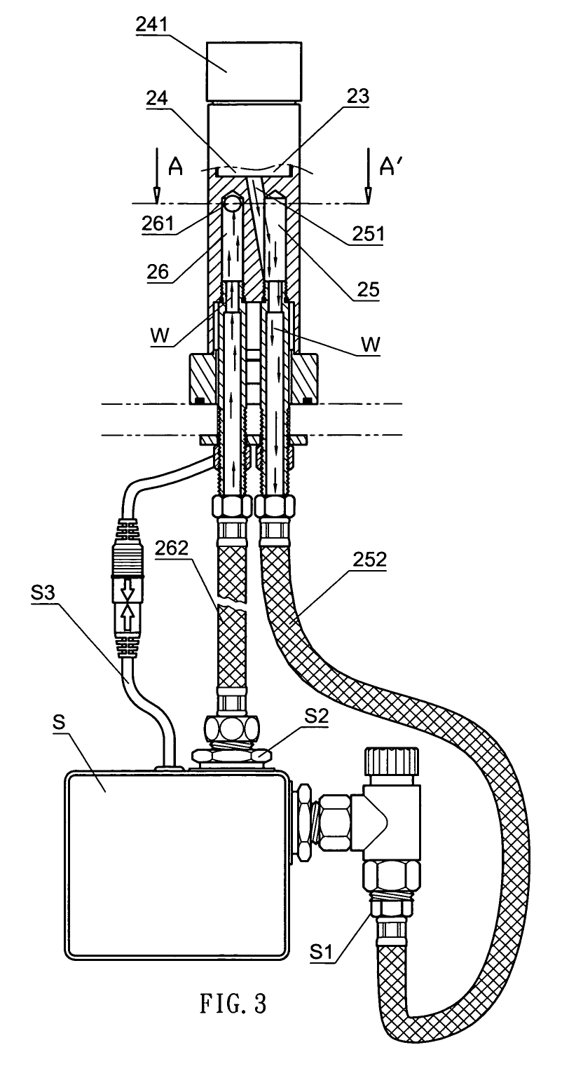

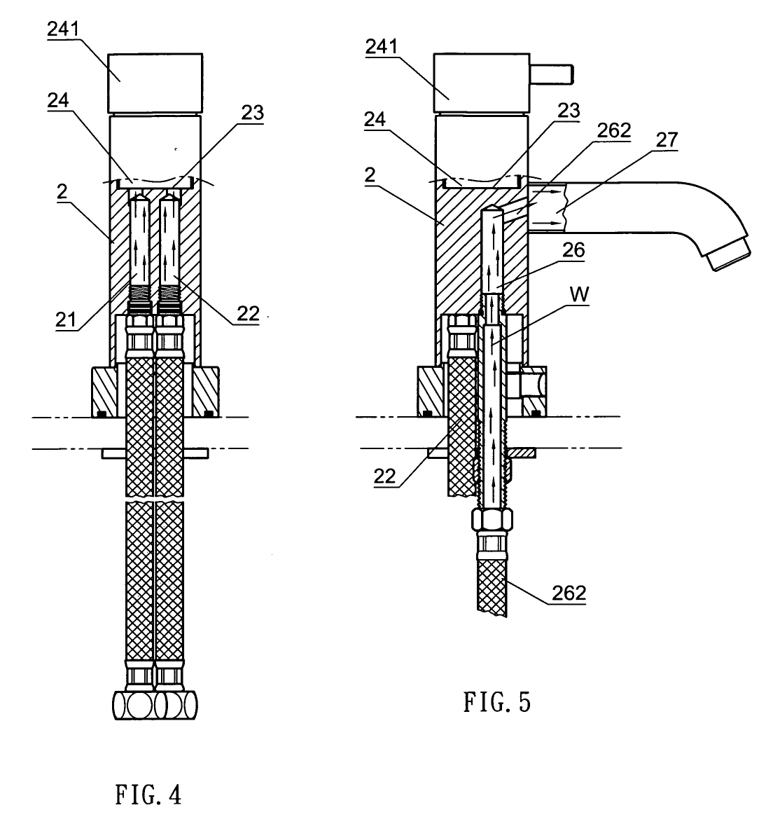

The improved structure and examples of this invention are hereby described with drawings in the following, and please refer to FIG. 1, FIG. 2, FIG. 2-A and FIG. 3. the improved structure of said temperature-controlled infrared sensor water faucet of this invention is comprised by cool water supply pipe 21 and hot water supply pipe 22 (please refer to FIG. 4) assembled from bottom to upward so that the mixing control ceramic valve 24 installed in the upper valve slot 23 can control cool and hot water as required, and the vertical water faucet 2 can flow out cool or hot water, or mixed water with setting temperature; wherein warm water supply pipe 25 with downward water channel 251 at one top to bear the adjusted warm water and side exit water outlet 261 at one top are respectively put through the front of valve slot 23 under the mixing control ceramic valve 24 and cool water supply pipe 21A and hot water supply hole 22A, so that the adjusted warm water W can flow out the outlet handle 27 from the warm water drainage channel 26 (please refer to FIG. 2-B and FIG. 5).

Thereby, the warm water supply channel 25 and drainage channel 26 are connected respectively to the water supply inlet S1 and outlet S2 of an infrared sensor S via water supply pipe 252 and drainage pipe 262; S3 is connected with infrared sensor S, and as the sensing terminal S4 installed at the middle of the front of water faucet 2 inducts hands moving toward lower part of outlet handle 27, it starts the infrared sensor S to open the internal water supply valve, the warm water W after adjusted is conducted into water supply inlet S1 through the downward water channel 251, warm water supply channel 25 and water supply pipe 252, and then drain toward the drainage pipe 262, warm water drainage channel 26 and water outlet 261 via outlet S2, finally, flow upward and go out from the outlet handle 27 of water faucet 2.

Basing on this structure, the user can turn left or right the operating handle 241 installed outside of the upper mixing control valve 24 before use, so as to directly set and adjust the mixed scale of cool & hot water, the required warm water W can flow out after the infrared sensor issued water supply instruction, it is specially used for the usual ceramic valve mixed temperature water faucet which can adjust the temperature of water by turning left or right, namely, the warm water can go out when your hands is approaching, furthermore, you can change the mixing scale of cool and hot water by the operating handle 241, that is to say, user can set the temperature of water as required conveniently. Therefore, user can be relieved from the traditional sensor water faucet in complicated structure and lots of trouble. Owing to its easy operation, it can be applicable to all homes, that is indeed the most important practical benefit of this invention.

To sum up all above descriptions, this invention can indeed improve the practical function of the infrared sensor water faucet, besides, it is convenient to produce and repair, therefore, it is in accordance with the requirements of a new patent.

What is claimed is:

1. An improved structure of temperature-controlled infrared sensor water faucet, which is comprised by cool water supply pipe and hot water supply pipe assembled from bottom to upward so that the mixing control ceramic valve installed in the upper valve slot can control cool and hot water as required, and the vertical water faucet can supply cool/hot water or mixed water with set temperature; wherein warm water supply pipe with downward water channel at one top to bear the adjusted warm water and side exit water outlet at one top are respectively put through the front of valve slot under the mixing control ceramic valve and cool & hot water supply hole, the adjusted warm water can flow out the outlet handle from the warm water drainage channel. Basing on this structure, the warm water supply channel and drainage channel can respectively be connected to the water supply inlet and outlet of an infrared sensor via water supply pipe and drainage pipe; which is connected out with an infrared sensor, and as the sensing terminal installed in the middle of the front of water faucet inducts the hands moving toward lower part of outlet handle, it starts infrared sensor and opens the internal water supply valve, warm water after adjusted is conducted into water supply inlet through the downward water channel, warm water supply channel and water supply pipe, then drain it upward to the drainage pipe and flow out from the outlet handle of water faucet at fixed time and quantity, so that the operating handle installed at outside of the upper mixing control ceramic valve can directly set and adjust the mixed scale of cool and warm water by turning left and right, so that the adjusted warm water can flow out after the infrared sensor issues instruction.
